(19) United States
(12) Patent Application Publication
(10) Pub. No.: US 2002/0164126 A1
(43) Pub. Date: Nov. 7, 2002

(54) Multi-port optical amplifier

(76) Inventors: Jae-Seung Lee, Seoul (KR); Kyung-Hee Seo, Seoul (KR)

Correspondence Address: David Tichane, 979 Pinto Palm Terrace, #24, Sunnyvale, CA, 94087, US

(21) Appl. No.: 10/193,957

(22) PCT Filed: Jan. 16, 2001
(86) PCT No.: PCT/KR01/00060

(51) Int. Cl. G02B 6/26

(52) U.S. Cl. 385/39; 385/27; 359/333

(57) ABSTRACT

A multi-port optical amplifier comprising two input ports and two output ports. The multi-port optical amplifier further comprises optical circulators instead of optical isolators provided in conventional optical amplifiers to suppress reflected waves.

### RELATED APPLICATIONS

The present application is a national phase PCT patent application under 35 USC 371 of serial no. PCT/KRO1/00060 filed on Jan. 16, 2001 claiming priority from Republic of Korea application serial no. 2000-2085 filed on Jan. 17, 2000.

### BACKGROUND OF THE INVENTION

1. Field of the Invention

The present invention relates in general to multi-port optical amplifiers, and more particularly to a multi-port optical amplifier which is designed to have two input ports and two output ports, thereby significantly reducing the number of optical amplifiers required for optical communication systems, optical measurement equipments and the like.

2. Description of the Prior Art

Optical amplifiers have been widely used in optical communication systems and general optical systems. Conventional optical amplifiers employ optical isolators to suppress the laser oscillation. The optical isolators act to prevent optical feedback components such as reflected waves from coming into the optical amplifier. The use of the optical isolators limits the number of input and output ports of the optical amplifier to one for each. In this regard, for a complex system, a very large number of optical amplifiers will be required, resulting in an increase in cost.

### SUMMARY OF THE INVENTION

Therefore, the present invention has been made in view of the above problem, and it is an object of the present invention to provide a multi-port optical amplifier which is designed to have two input ports and two output ports, thereby significantly reducing the number of optical amplifiers required for optical communication systems, optical measurement equipments and the like.

It is another object of the present invention to provide a multi-port optical amplifier that is designed to have two different input ports, thereby amplifying two input signals individually with little crosstalk therebetween.

In accordance with the present invention, the above and other objects can be accomplished by the provision of a mult-port optical amplifier comprising two input ports, two output ports, at least one gain means having bidirectional amplification capabilities, and two optical circulators, thereby simultaneously amplifying different optical signals traveling along two optical fibers.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of a multi-port optical amplifier in accordance with the present invention; and

FIG. 2 is a block diagram showing the construction of an add-drop multiplexer (ADM) optical amplifier in accordance with the present invention.

### DETAILED DESCRIPTION OF THE PREFERRED EMBODIMENTS

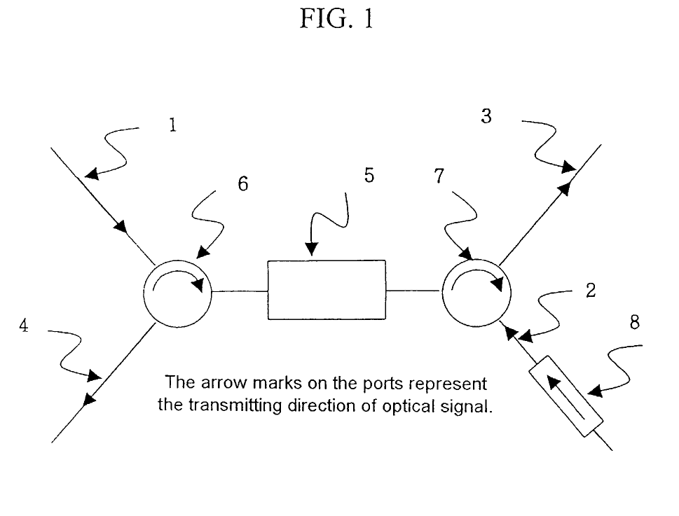

FIG. 1 is a block diagram schematically showing the construction of a multi-port optical amplifier in accordance with the present invention. As shown in this drawing, the multi-port optical amplifier comprises first and second input ports 1 and 2 for inputting two signals, respectively, gain means 5 for amplifying the two signals inputted through the first and second input ports 1 and 2, and first and second output ports 3 and 4 for outputting the two signals amplified by the gain means 5, respectively. The two signals inputted to the first and second input ports 1 and 2 are propagated to the gain means 5 in opposite directions and then amplified by the gain means 5. The gain means 5 may preferably be a bidirectional amplification area of an optical fiber amplifier or a semiconductor amplifier having no optical isolators.

The gain means 5 has a typical problem in that a signal amplification characteristic becomes unstable due to laser oscillation resulting from optical feedback components such as reflected waves at the input/output ports. In order to suppress such laser oscillation, a conventional optical fiber amplifier further comprises optical isolators provided in the input/output ports or gain means. However, in the present invention, optical circulators are provided instead of the optical isolators to suppress the optical feedback components.

Namely, in FIG. 1, optical feedback components resulting from reflected waves generated at the output ports are not inputted directly to the gain means 5, but transferred toward different input ports by optical circulators 6 and 7. Then, the transferred components are again reflected and fed to the gain means 5. As a result, the amount of components fed to the gain means 5 is so small as to effectively suppress laser oscillation. Provided that the gain means 5 is high in gain, the presence of an optical isolator 8 on at least one of the port paths will also suppress the laser oscillation as long as the optical isolator 8 has the same path direction as a signal traveling direction.

The optical isolator 8 is not necessarily required, and can be omitted if it is included in a light source for the generation of signals. With the above construction, the multi-port optical amplifier can amplify two optical inputs at the same time, so that optical amplifiers required for optical communication systems, optical measurement equipments and the like can be significantly reduced in number.

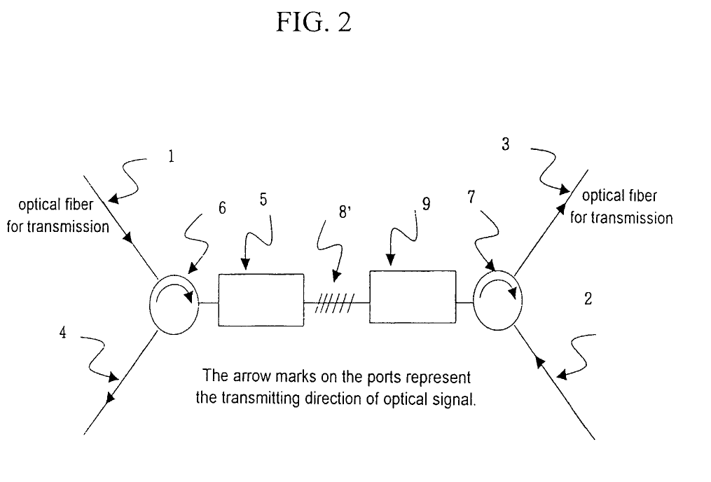

FIG. 2 is a block diagram showing the construction of an add-drop multiplexer (ADM) optical amplifier in accordance with the present invention, wherein at least one optical filter such as an optical fiber grating is provided in the gain means. For example, in the case where an optical filter 8′ is of a reflection type, such as the optical fiber grating, and an optical signal is transmitted from the first input port 1 to the first output port 3, signal wavelength components traveling along an optical fiber for transmission are partially reflected by the optical filter 8′ and then dropped to the second output port 4. Alternatively, a new optical signal may be inputted to the second input port 2 and then travel along the optical fiber for transmission. As compared with the existing optical amplifier structure wherein an optical signal is passed through an ADM device and then amplified by an optical amplifier, the above ADM optical amplifier is economical in that it requires a reduced number of essential elements such as optical isolators. In the drawing, the left gain means 5 acts as a preamplifier for amplifying a dropped signal, and the right gain means 9 acts as a high-power amplifier for amplifying an added signal. As an alternative, any one of the two gain means 5 and 9 may be omitted.

As apparent from the above description, the present invention provides a multi-port optical amplifier that is capable of simultaneously amplifying different optical signals traveling along two optical fibers. Therefore, optical amplifiers required for optical communication systems, optical measurement equipments and the like can be significantly reduced in number. Further, an ADM function can be very easily added to the present optical amplifier, thereby preventing the duplicate use of devices and maximizing economization.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A multi-port optical amplifier comprising two input ports, two output ports, at least one gain means having a bidirectional amplification capability, and two optical circulators, thereby simultaneously amplifying different optical signals traveling along two optical fibers.

2. A multi-port optical amplifier as set forth in claim 1, further comprising optical isolators provided in some or all of said input and output ports.

3. A multi-port optical amplifier as set forth in claim 1, wherein said gain means is connected between said two optical circulators and wherein said multi-port optical amplifier further comprises at least one optical filter connected to said gain means, thereby implementing an optical add-drop multiplexing function.
